(19) United States
(12) Patent Application Publication
(10) Pub. No.: US 2026/0145739 A1
(43) Pub. Date: May 28, 2026

(54) APPARATUS FOR ADJUSTING A TIE ROD

(71) Applicant: BPG Sales and Technology Investments, LLC, Shelby Township, MI (US)

(72) Inventors: Steve Cipolla, Grand Haven, MI (US); Carter J. Cobb, Grand Rapids, MI (US); Paul Kitchen, Norton Shores, MI (US); Alex Vander Tuig, Grand Rapids, MI (US); Daniel Houseward, Grand Rapids, MI (US)

(21) Appl. No.: 19/402,124

(22) Filed: Nov. 26, 2025

Related U.S. Application Data
(60) Provisional application No. 63/726,026, filed on Nov. 27, 2024.

(51) Int. Cl. B62D 17/00; B25J 15/00

(52) U.S. Cl. CPC B62D 17/00; B25J 15/00

(57) ABSTRACT

A tie rod adjustment apparatus comprising a pair of supports for locating and engaging with a tie rod, and a pair of adjustment heads disposed between the supports, where a first one of the adjustment heads is configured for engaging and rotating a jam nut of the tie rod and a second of the adjustment heads is configured for engaging and rotating a rotatable tie rod end of the tie rod. The supports are configured to be stationary when engaged with the tie rod and the pair of adjustment heads are moveable along the tie rod between the stationary supports for selectively engaging the first adjustment head with the jam nut and engaging the second adjustment head with the rotatable tie rod end.

### CROSS REFERENCE TO RELATED APPLICATION

The present application claims the priority benefit of U.S. provisional patent application Ser. No. 63/726,026 filed Nov. 27, 2024, which is hereby incorporated herein by reference in its entirety.

### BACKGROUND AND FIELD OF THE DISCLOSURE

The present disclosure relates to an apparatus for adjusting a tie rod on a vehicle.

Vehicles include steering systems that can be adjusted to set wheel alignment parameters such as, for example, caster, camber, and toe angles of drive wheels, this includes tie rods that are coupled to the steerable wheels of the vehicle. Tie rods include two ends that are threaded together for adjusting the length of the tie rod and include a lock or jam nut for fixing the length of the tie rod. The jam nut can be disposed in a loosened position, which allows the tie rod ends to be rotated relative to each other for expanding and contracting the tie rod, and the jam nut can be disposed in a locked position for securing the tie rod ends together at a desired length. For example, the length of a tie rod may be adjustably expanded and contracted to move a steerable front wheel outward or inward to either decrease or increase the toe angle of the wheel.

During assembly of vehicles, as part of a process of setting vehicle wheel alignment parameters, tie rod adjustment tools may be used that loosen the jam nut, adjust the length of the tie rod and then tighten the jam nut.

### SUMMARY

A tie rod adjustment apparatus in accordance with aspects of the disclosure comprises a pair of supports for locating and engaging with a tie rod and a pair of adjustment heads disposed between the supports. A first one of the adjustment heads is configured for engaging and rotating a jam nut of the tie rod and a second of the adjustment heads is configured for engaging and rotating a rotatable tie rod end of the tie rod. The supports are configured to be stationary when engaged with the tie rod and the pair of adjustment heads are moveable along the tie rod between the stationary supports for selectively engaging the first adjustment head with the jam nut and engaging the second adjustment head with the rotatable tie rod end.

In accordance with particular embodiments, the adjustment heads are separately and independently moveable with respect to one another. The supports each comprise engaging ends for engagement with the tie rod, and each engaging end may include an opening for receiving the tie rod therein.

In accordance with particular embodiments, the supports and adjustment heads are coupled to an arm assembly that is configured to enable the supports and adjustment heads to pivot about at least one axis of the arm assembly to aid engagement of the supports and adjustment heads with the tie rod. The arm assembly may be configured to enable the supports and adjustment heads to pivot about a pair of perpendicular axes of the arm assembly to aid engagement of the supports and adjustment heads with the tie rod. Still further, the arm assembly may be configured to enable the supports and adjustment heads to pivot about three mutually perpendicular axes of the arm assembly to aid engagement of the supports and adjustment heads with the tie rod.

In accordance with a particular embodiment, the arm assembly comprises a cradle assembly that defines at least one axis about which the supports and adjustment heads are configured to pivot. Still further, the cradle assembly may comprise a first cradle defining a first axis and a second cradle defining a second axis, where the second cradle is mounted with the first cradle so as to pivot about the second axis. In such embodiments the cradle assembly may be connected with biasing members configured to bias the supports and adjustment heads into a set orientation.

In any of the embodiments, the supports and adjustment heads may be coupled to the arm assembly by a shaft defining a longitudinal axis of the tie rod adjustment apparatus, where the supports and adjustment heads are rotatable about the shaft.

In still further embodiments, the arm assembly is coupled to an extension cylinder configured to extend the supports and adjustment heads into a deployed or engaged position to engage the tie rod and to retract the supports and adjustment heads into a retracted position. In such a configuration the arm assembly may be mounted to a frame via linear rails, and wherein the extension cylinder is coupled to the frame.

In accordance with further aspects of the present disclosure, a method of adjusting a tie rod of a vehicle with a tie rod adjustment apparatus having a pair of supports for locating and engaging with a tie rod and a pair of adjustment heads disposed between the supports includes extending the supports and adjustment heads from a retracted position and engaging the supports and adjustment heads with the tie rod so as to be in an engaged position in which the supports and adjustment heads are engaged with the tie rod. The method further includes moving the adjustment heads between the supports while the supports remain stationary on the tie rod, where the moving comprises engaging a first one of the adjustment heads with a jam nut of the tie rod and rotating the jam nut and engaging a second of the adjustment heads with a rotatable tie rod end of the tie rod and rotating the rotatable tie rod end, where the pair of adjustment heads are moveable along the tie rod between the stationary supports for selectively engaging the first adjustment head with the jam nut and engaging the second adjustment head with the rotatable tie rod end. The method further includes retracting the supports and adjustment heads from the engaged position to the retracted position in which the supports and adjustment heads are disengaged from the tie rod.

In accordance with particular aspects, the step of moving comprises separately and independently moving the adjustment heads with respect to one another.

In accordance with a further aspect of the disclosure, the supports and adjustment heads are coupled to an arm assembly having at least one pivot axis, where the method further comprises pivoting the supports and adjustment heads about the at least one pivot axis during the step of engaging the supports and adjustment heads with the tie rod.

In a particular aspect, the arm assembly has a plurality of mutually perpendicular pivot axes, and the method further comprises pivoting the supports and adjustment heads about the pivot axes during the engaging of the supports and adjustment heads with the tie rod.

The arm assembly may comprise a cradle assembly defining two mutually perpendicular pivot axes. The supports and adjustment heads may be coupled to the arm assembly by a shaft defining a longitudinal axis of the tie rod adjustment apparatus, where the supports and adjustment heads are rotatable about said shaft.

Still further, the tie rod apparatus may include an extension cylinder configured to extend the supports and adjustment heads into the engaged position and to retract the supports and adjustment heads into the retracted position.

The tie rod adjustment apparatus of the present invention enables a tool assembly comprising supports and adjustment heads to be accurately located and fixed on the tie rod, with the adjustment heads moving between the supports of the tool assembly. The tie rod adjustment apparatus is additionally configured to be pivotable about multiple axes to aid in locating the apparatus on the tie rod.

These and other objects, advantages, purposes, and features of this disclosure will become apparent upon review of the following specification in conjunction with the drawings.

### BRIEF DESCRIPTION OF DRAWINGS

FIG. 1 is a perspective view of a tie rod and a portion of a tie rod adjustment apparatus in accordance with the present disclosure having adjustment heads for adjusting the tie rod;

FIG. 2 is another perspective view of the tie rod and tie rod adjustment portion of FIG. 1 with the adjustment heads disposed in different positions;

FIG. 3 is a front, left perspective view of the tie rod adjustment apparatus of FIG. 1;

FIG. 4 is a left side elevation view of the apparatus of FIG. 1;

FIG. 5 is a front elevation view of the apparatus of FIG. 1;

FIG. 6 is a right side elevation view of the apparatus of FIG. 1;

FIG. 7 is a partial front elevation view of an upper portion of the apparatus of FIG. 1;

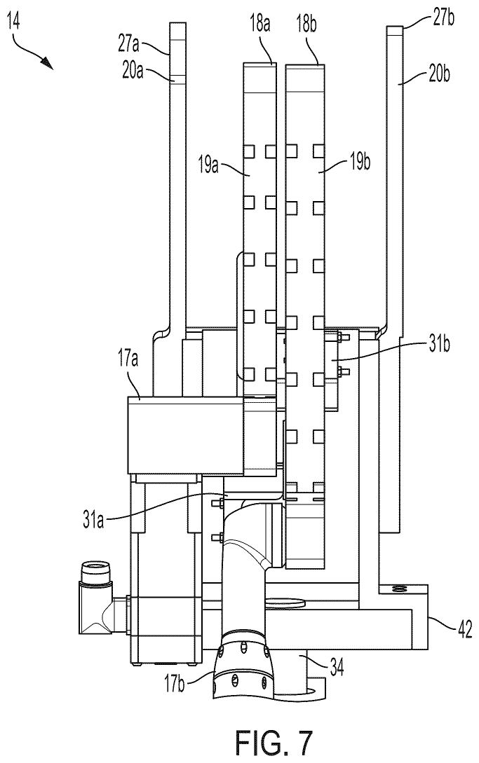

FIG. 8 is a partial front perspective view of the upper portion of the apparatus of FIG. 1 from an alternative angle relative to FIG. 7;

FIG. 9 is a partial front, left perspective view of a portion of the apparatus of FIG. 1;

FIG. 10 is a partial front, left perspective view of a portion of the apparatus of FIG. 1;

FIG. 11 is a partial rear, right perspective view of a portion of the apparatus of FIG. 1;

FIG. 12 is a partial front, right perspective view of a portion of the apparatus of FIG. 1;

FIG. 13 is a partial front, right perspective view of a portion of the apparatus of FIG. 1;

FIG. 14 is a partial rear, left perspective view of a portion of the apparatus of FIG. 1;

FIG. 15 is a partial front, right perspective view of a portion of the apparatus of FIG. 1;

FIG. 16 is a partial front, right perspective view of a portion of the apparatus of FIG. 1.

FIG. 17 is a partial sectional perspective view of a portion of the apparatus of FIG. 1; and

FIG. 18 is a partial front, right perspective view of a lower portion of the apparatus of FIG. 1.

### DETAILED DESCRIPTION

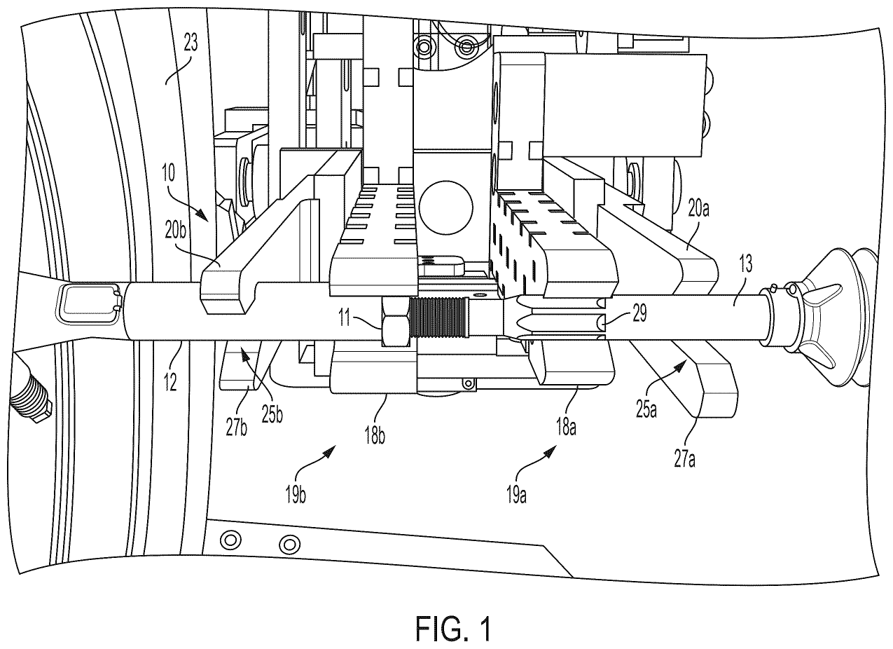

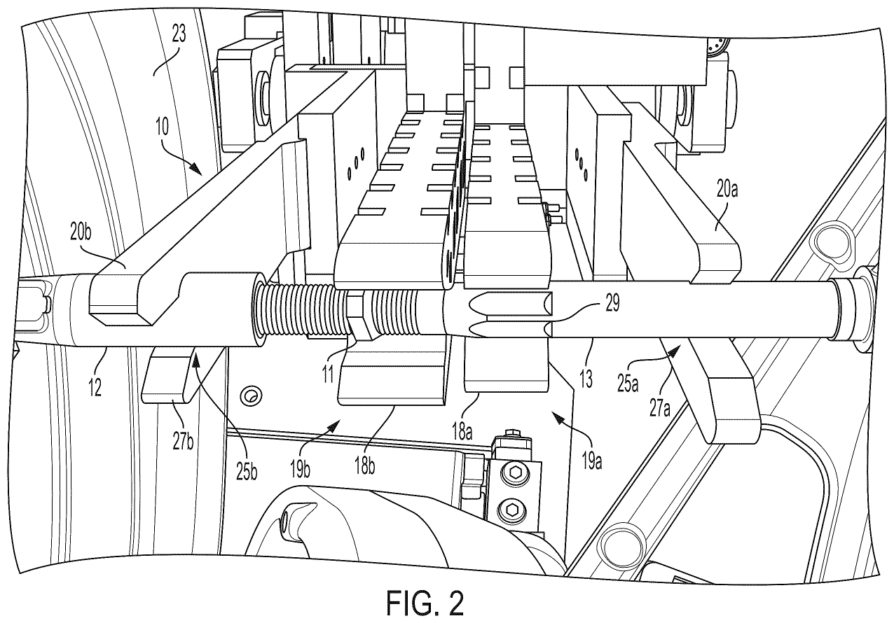

Referring now to the drawings and illustrative examples depicted therein, a tie rod adjustment apparatus 10 for adjusting a tie rod 12 is shown that includes a tool or drive tool assembly 14 for adjusting tie rod 12 by loosening a lock or jam nut 11 of tie rod 12, rotating an inner tie rod end 13 of tie rod 12, and subsequently tightening jam nut 11. (FIGS. 1-3). Tool assembly 14 is coupled with an arm or support assembly 16 having a pair of pivotable cradles 15a, 15b, with arm assembly 16 in turn being slidingly mounted to a frame 21 such that arm assembly 16 together with tool assembly 14 may be extended and retracted relative to frame 21. Frame 21 in turn is supportable on a robotic arm (not shown) in conventional manner to maneuver tie rod adjustment apparatus 10 underneath a vehicle, such as during assembly of the vehicle.

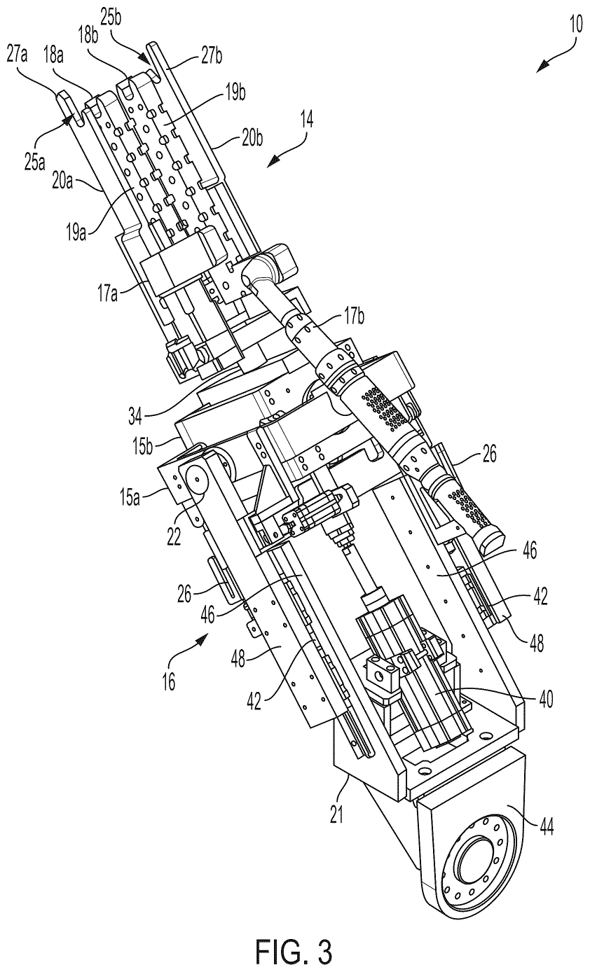

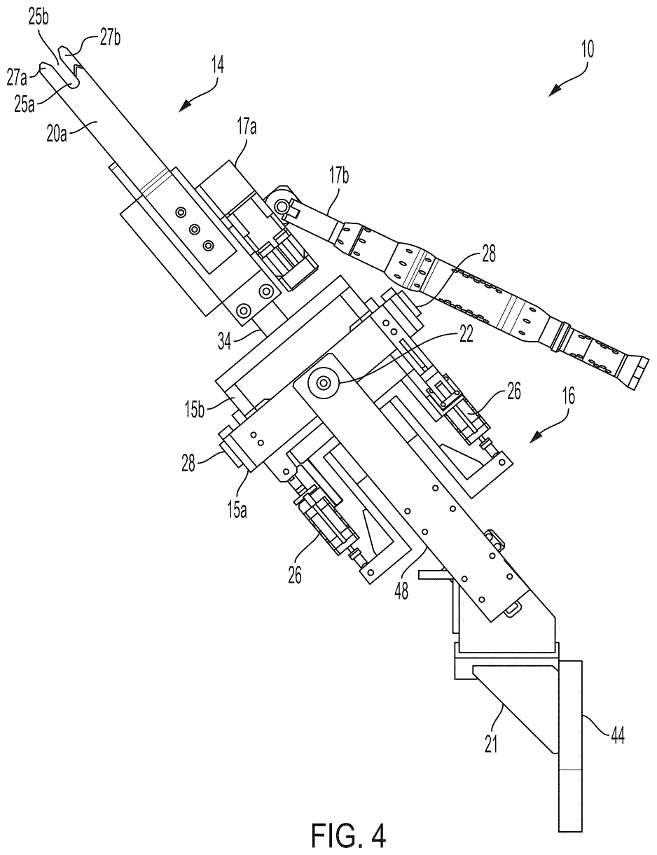

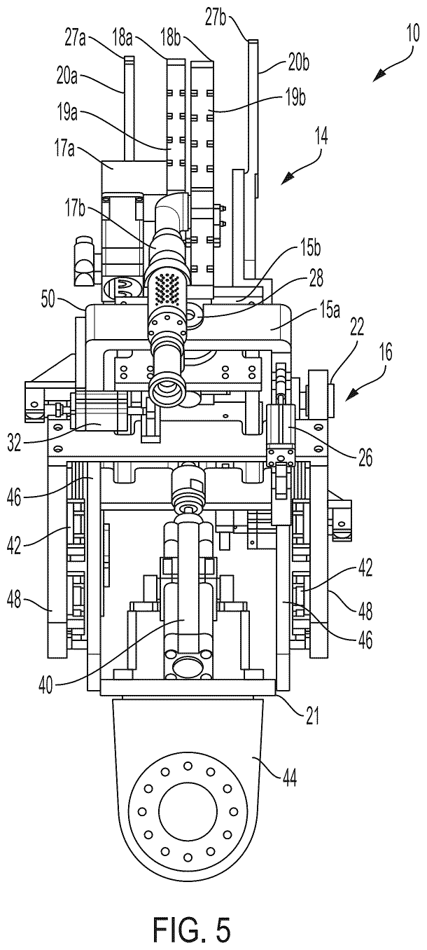

As discussed in more detail below, tool assembly 14 includes a pair of adjustment gear heads 18a, 18b for contacting and rotating tie rod 12 and jam nut 11, respectively. Tool assembly 14 includes a pair of drive tool actuators 17a, 17b that are operatively coupled to respective adjustment heads 19a, 19b for actuating or driving the adjustment gear heads 18a, 18b. (FIGS. 3-5). Tool assembly 14 further includes a pair of spaced apart supports 20a, 20b configured as guide plates located outwardly of adjustment gear heads 18a, 18b. In operation, supports 20a, 20b are configured to engage tie rod 12 when tool assembly 14 is moved into a deployed position so as to locate tool assembly 14 for engagement with the tie rod 12. Once engaged, supports 20a, 20b remain stationary while adjustment gear heads 18a, 18b are moved inwardly and outwardly along tie rod 12 in between supports 20a, 20b to rotate jam nut 11 and inner tie rod end 13 for adjusting and setting the toe angle of the wheel assembly 23. Adjustment gear heads 18a, 18b can be independently moved along the tie rod 12 from one another between the stationary supports 20a, 20b, as well as can be independently driven by their respective actuators 17a, 17b to rotate the tie rod end 13 and jam nut 11.

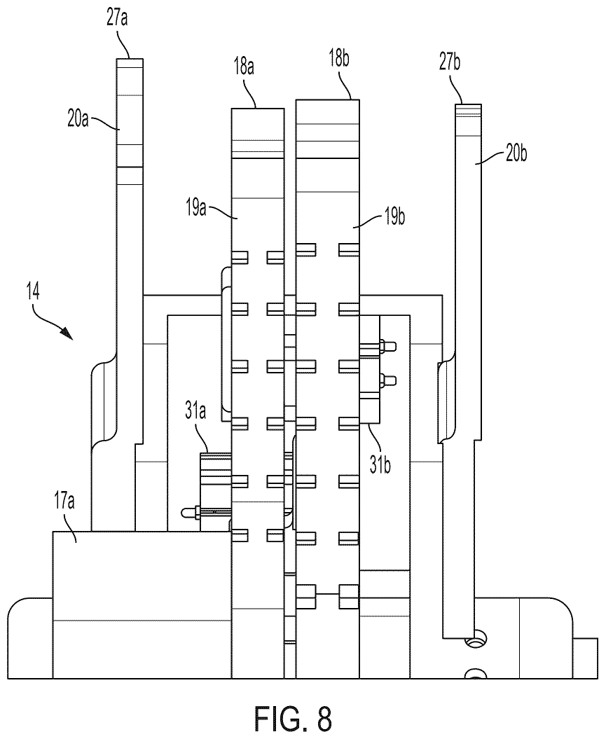

As shown throughout the drawings, supports 20a, 20b each includes an opening 25a, 25b at their tie rod engaging ends 27a, 27b, with openings 25a, 25b configured for engagement with the tie rod 12. And as illustrated, support 20a engages with the tie rod 12 inwardly of hexagonal flats 29 on inner tie rod end 13 and support 20b engages with tie rod 12 outwardly of jam nut 11, where inwardly and outwardly are relative to the vehicle in conventional manner. As such, adjustment gear heads 18a, 18b are able to move along tie rod 12 in between supports 20a, 20b while being able to engage and release from flats 29 and jam nut 11. Adjustment gear heads 18a, 18b are additionally moveable inwardly and outwardly along tie rod 12 independently of one another. Accordingly, adjustment gear head 18b may first be engaged with jam nut 11 to loosen jam nut 11, as shown in FIG. 1, by activation of adjustment head 19b by actuator 17b. Adjustment gear head 18b may subsequently be moved off of jam nut 11 while adjustment gear head 18a is engaged with flats 29 whereby activation of adjustment head 19a via actuator 17a may turn inner tie rod end 13 in or out. Upon reaching the desired toe set value for the wheel assembly 23, adjustment head 19a may be moved back to engage adjustment gear head 18a with jam nut 11 for tightening jam nut 11. Drive assembly 14 includes a pair of drive adjustment head actuators 31a, 31b operatively coupled to respective adjustment heads 19a, 19b for independently moving adjustment heads 19a, 19b, and thus adjustment gear heads 18a, 18b, with respect to one another between supports 20a, 20b so as to be moveable along tie rod 12 when tool assembly 14 is engaged therewith. (FIG. 8).

Adjustment gear heads 18a, 18b may comprise a C-gear or tubular socket for enabling the adjustment gear heads 18a, 18b to engage with the tie rod 12 and rotate the jam nut 11 and inner tie rod end 13. For example, the adjustment heads may be constructed and operate in similar manner to the adjustment head disclosed in U.S. Pat. No. 8,082,822, which is incorporated herein by reference in its entirety. As noted, adjustment heads 19a, 19b are driven by actuators 17a, 17b, where adjustment heads may comprise gears and/or chain drives for rotating the gear heads. Actuators 17a, 17b may be pneumatically or electrically driven, or the like.

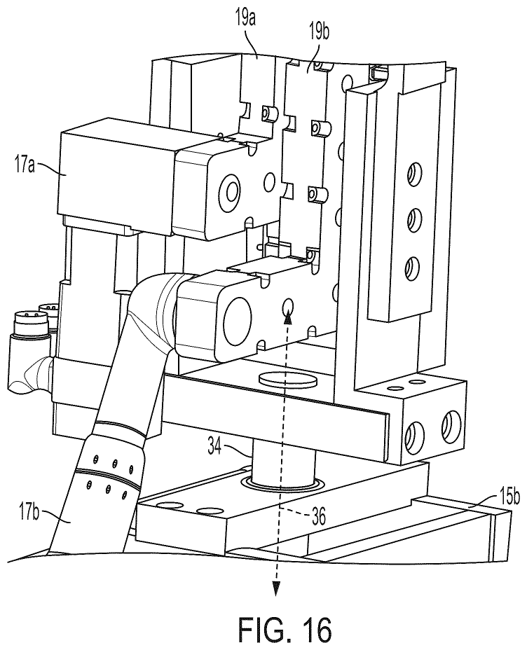

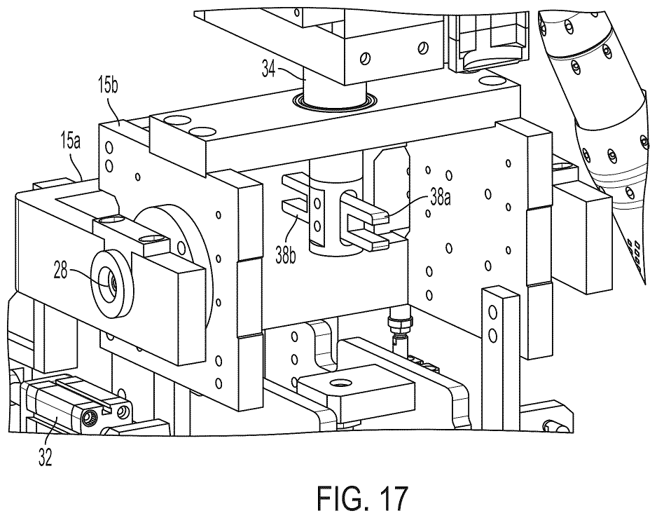

As noted, tool assembly 14 is coupled with arm assembly 16. In particular, tool assembly 14 is coupled to arm assembly 16 by a shaft 34 (FIGS. 16 and 17) with arm assembly 16 providing some movement or play to tool assembly 14 about three mutually perpendicular axes such that when tool assembly 14 is moved into engagement with a tie rod 12, tool assembly 14 is able to be located thereon.

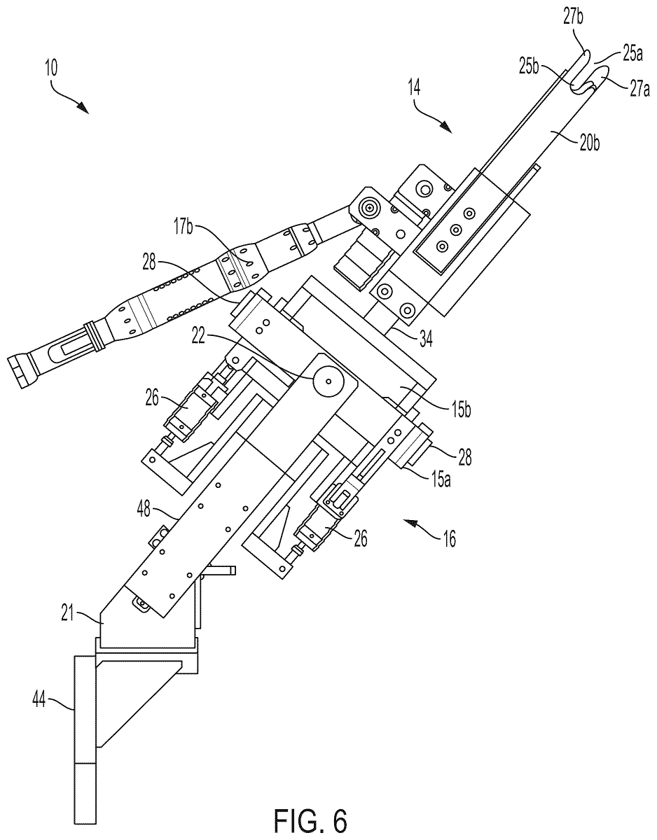

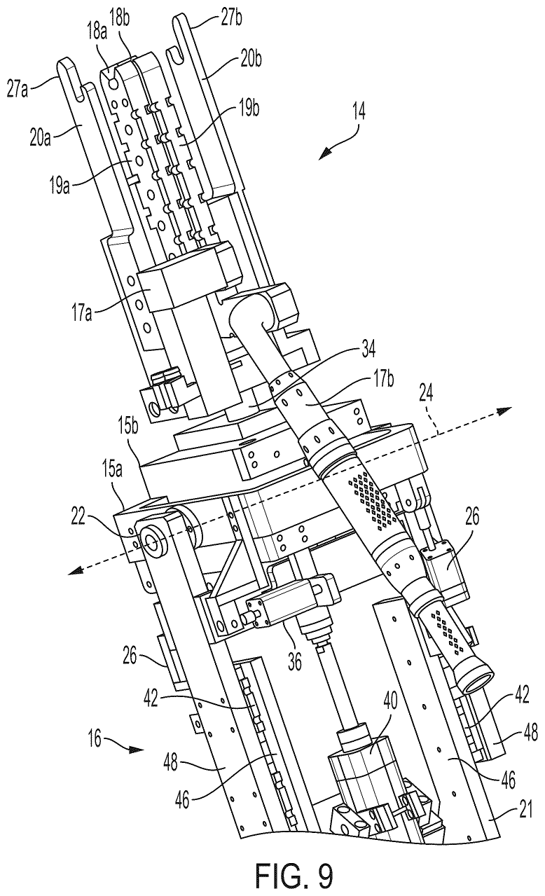

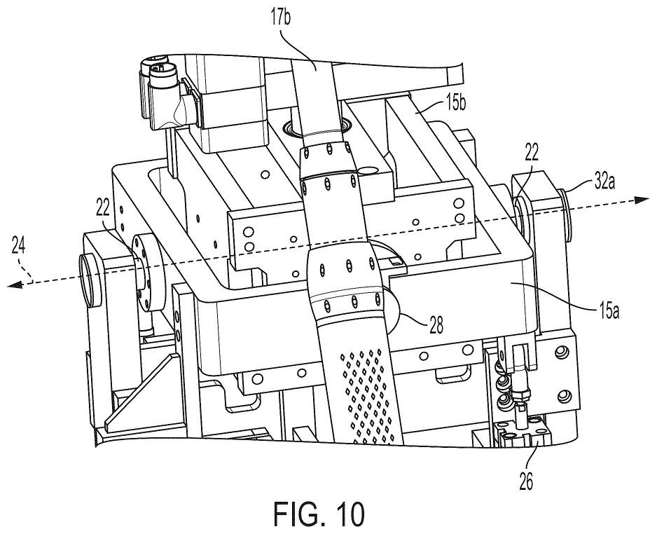

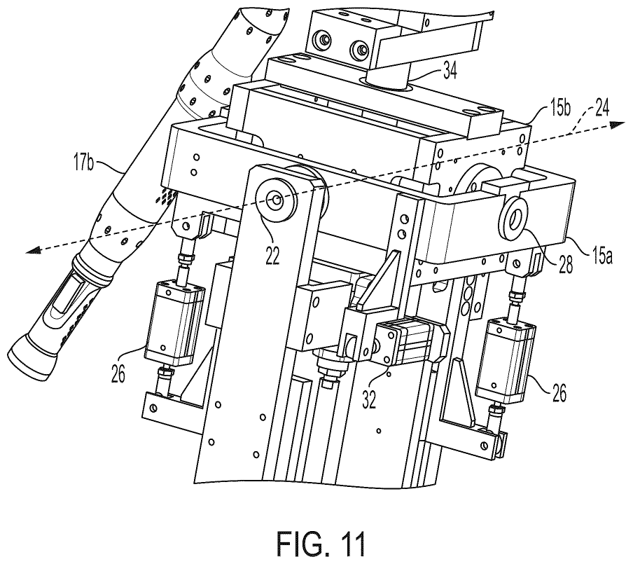

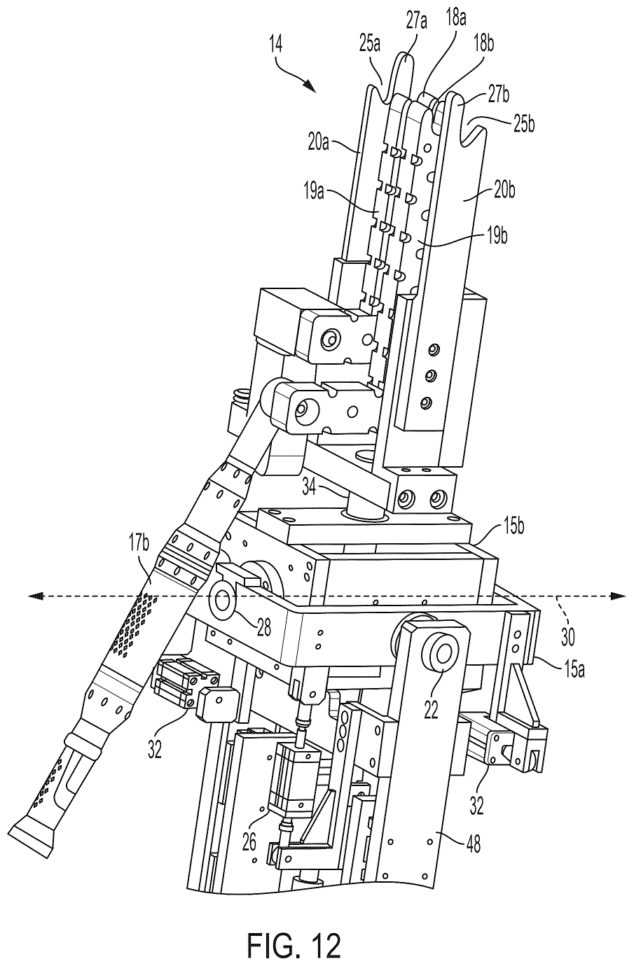

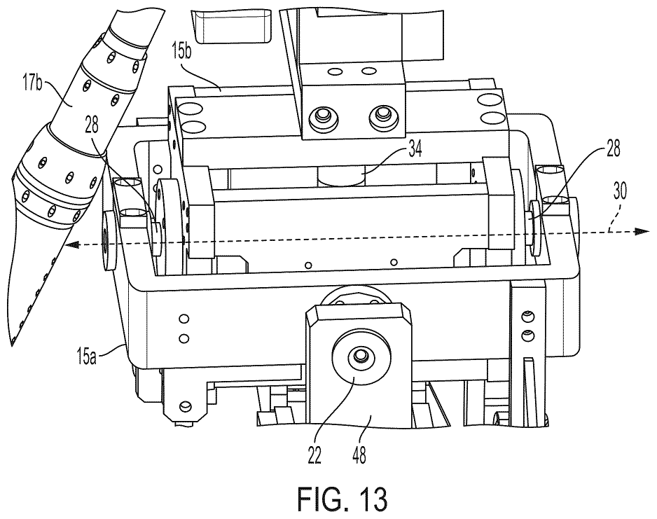

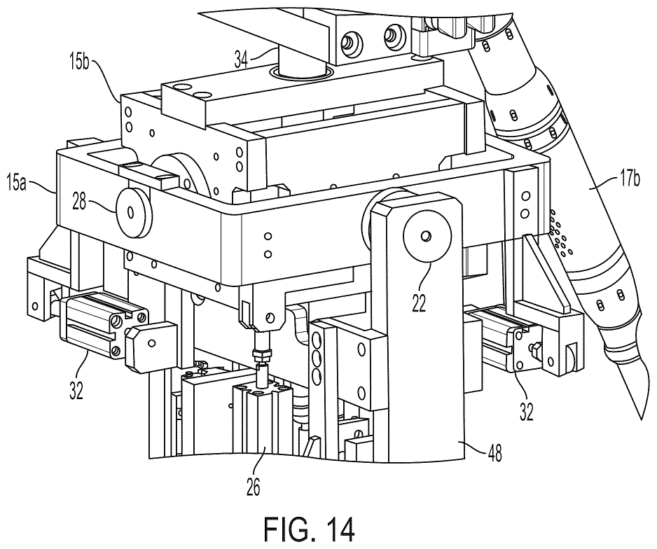

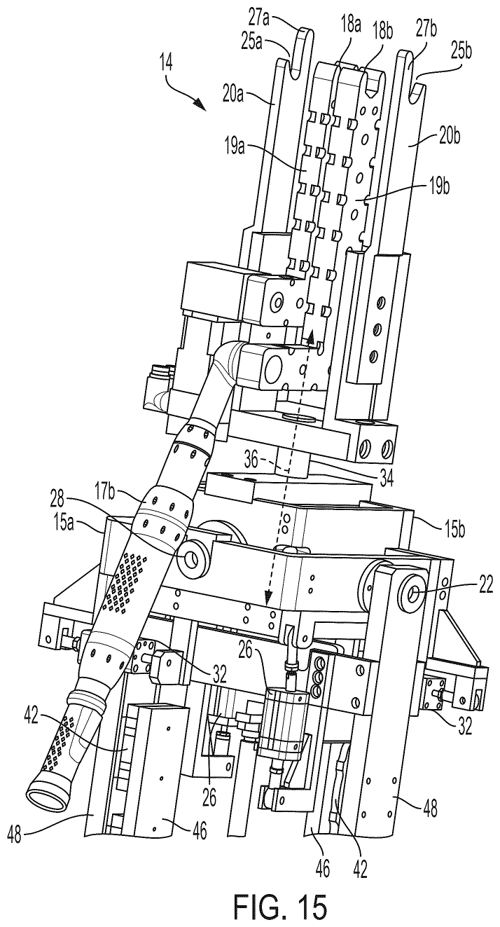

Arm assembly 16 includes a pair of nested cradles 15a, 15b that are pivotable about perpendicular axes 24, 30. (See FIGS. 3-6 and 9-15.) Cradle 15a is mounted via shafts 22 so as to be pivotable about axis 24. Cradle 15b, in turn, is mounted within cradle 15a via shafts 28 so as to be pivotable about axis 30. Arm assembly 16 further includes a pair of biasing members configured as balancing cylinders 26 connected with cradle 15a to allow some movement or play of cradle 15a about axis 24, and similarly includes a pair of biasing members configured as balancing cylinders 32 connected with cradle 15b to allow some movement or play of cradle 15b about axis 30.

As shown throughout the figures, two balancing cylinders 26 are connected with cradle 15a, with the pair of balancing cylinders 26 being opposed from one another on opposite sides of cradle 15a relative to each other. It is thus appreciated that the balancing cylinders 26 allow cradle 15a to have some play to thereby rotate about axis 24 in each direction but will bias cradle 15a back to the normal position shown in the figures. As also shown throughout the figures, two balancing cylinders 32 are connected with cradle 15b, and in turn with cradle 15a, with the pair of balancing cylinders 32 being opposed from one another on opposite sides of cradle 15b relative to each other. It is thus further appreciated that the balancing cylinders 32 allow cradle 15b to have some play to thereby rotate about axis 30 in each direction but will bias cradle 15b back to the normal position shown in the figures. In the illustrated embodiment, balancing cylinders 26, 32 are configured as air cylinders. However, any other suitable biasing member may be employed, including alternative suitable cylinders, springs or the like.

As shown in FIGS. 16 and 17, tool assembly 14 is further coupled to arm assembly 16 so as to be rotatable about a third axis 36 defined by shaft 34. Arm assembly 16 further includes biasing members (not shown) mounted to shaft 34 within cradle 15b at mounts 38a, 38b to provide for some movement or play about axis 36 to thereby enable the tool assembly 14 to engage with the tie rod 12. Such biasing members may be, for example, balancing cylinders such as cylinders 26, 32 discussed above.

As noted above, arm assembly 16 is in turn coupled to frame 21 where, as best shown in FIGS. 3, 5, 9, 12, 15 and 18, arm assembly 16 is mounted to frame 21 for sliding extension and retraction of arm assembly 16 relative to frame 21 by an extension cylinder 40. In particular, arm assembly 16 is coupled to frame 21 by linear rails 42 that enable arm assembly 16 to slide upwardly via extension of cylinder 40 and enable arm assembly 16 to slide downwardly via retraction of cylinder 40. Frame 21 includes a mount 44 for connecting frame 21 with a robot, such as in the incorporated by reference U.S. Pat. No. 8,082,822.

In operation, tie rod adjustment apparatus 10 is mounted to a robot that is configured to maneuver apparatus 10 from beneath a vehicle into initial alignment for engagement with the tie rod 12 of the vehicle, where the robot may be disposed within a pit or the vehicle may be on an elevated platform or rail system, or the like.

Upon the robot initially maneuvering apparatus 10 into position, cylinder 40 is used to extend apparatus 10 into a deployed position whereby arm assembly 16 along with tool assembly 14 coupled thereto are extended into engagement with the tie rod 12. In particular, supports 20a, 20b engage with tie rod 12 at openings 25a, 25b, with arm assembly 16 allowing for movement about axes 24, 30, 36 to account for any alignment issues in the engagement of tool assembly 14 with tie rod 12.

Once tool assembly 14 is engaged with tie rod 12, adjustment heads 19a, 19b and thus their corresponding adjustment gear heads 18a, 18b may be moved independently from one another in between stationary supports 20a, 20b for selective engagement with the jam nut 11 and flats 29 on inner tie rod end 13. For example, as shown in FIG. 1, adjustment gear head 18a is shown engaged with the flats 29 on inner tie rod end 13 and adjustment gear head 18b is shown engaged with the jam nut 11. Adjustment gear head 18b may first loosen jam nut 11, which involves backing it off from engagement with the outer tie rod end by actuator 17b driving adjustment head 19b. Adjustment gear head 18a while in engagement with hex flats 29 may then be used to rotate inner tie rod end 13 by actuator 17a driving adjustment head 19a to either shorten or increase the length of the tie rod 12 to thereby set the toe alignment of the wheel assembly 23. Upon obtaining the proper toe alignment, adjustment gear head 18b may subsequently tighten the jam nut 11 to secure the tie rod 12 in position.

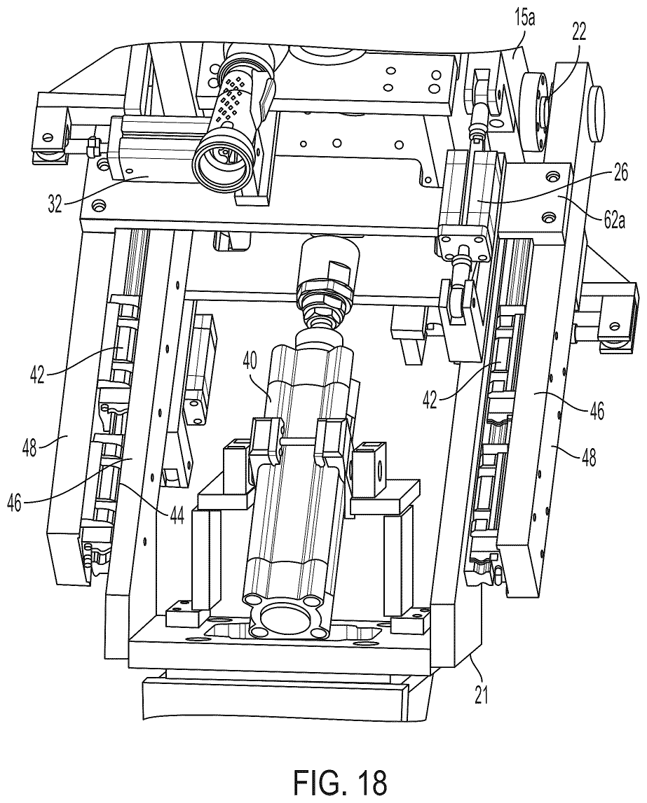

Once the desired toe alignment is obtained, cylinder 40 may retract arm assembly 16 so as to slide along frame 21 on rails 42 such that tool assembly 14 disengages with the tie rod 12 and is in a retracted or stowed position. As best understood from FIGS. 3 and 18, frame 21 includes extension members 46 and arm assembly 16 includes a pair of extension arms 48 with rails 42 mounted therebetween for extension and retraction of arm assembly 16, and thereby tool assembly 14, relative to frame 21.

It should be appreciated that, depending on the size of a given tie rod and spacing of a given vehicle, that various movements of the adjustment heads 19a, 19b between the stationary supports 20a, 20b may need to be performed in order to loosen the jam nut 11 and turn the tie rod end 13. For example, adjustment head 19a may initially need to be positioned inwardly adjacent support 20a in order to provide room for adjustment head 19b to engage adjustment gear head 18b with jam nut 11. Upon loosening of jam nut 11, adjustment head 19b may then be moved outwardly toward support 20b in order to provide room for adjustment head 19a to be moved outwardly to engage with flats 29.

Changes and modifications in the specifically described examples can be carried out without departing from the principles of the present disclosure which is intended to be limited only by the scope of the appended claims, as interpreted according to the principles of patent law including the doctrine of equivalents.

1. A tie rod adjustment apparatus comprising:
a pair of supports for locating and engaging with a tie rod;
a pair of adjustment heads disposed between the supports, wherein a first one of the adjustment heads is configured for engaging and rotating a jam nut of the tie rod and a second of the adjustment heads is configured for engaging and rotating a rotatable tie rod end of the tie rod;
wherein the supports are configured to be stationary when engaged with the tie rod and the pair of adjustment heads are moveable along the tie rod between the stationary supports for selectively engaging the first adjustment head with the jam nut and engaging the second adjustment head with the rotatable tie rod end.

2. The apparatus of claim 1, wherein the adjustment heads are separately and independently moveable with respect to one another.

3. The apparatus of claim 1, wherein the supports each comprise engaging ends for engagement with the tie rod, and wherein each engaging end comprises an opening for receiving the tie rod therein.

4. The apparatus of claim 1, wherein the supports and adjustment heads are coupled to an arm assembly, and wherein the arm assembly is configured to enable the supports and adjustment heads to pivot about at least one axis of the arm assembly to aid engagement of the supports and adjustment heads with the tie rod.

5. The apparatus of claim 4, wherein the arm assembly is configured to enable the supports and adjustment heads to pivot about a pair of perpendicular axes of the arm assembly to aid engagement of the supports and adjustment heads with the tie rod.

6. The apparatus of claim 4, wherein the arm assembly is configured to enable the supports and adjustment heads to pivot about three mutually perpendicular axes of the arm assembly to aid engagement of the supports and adjustment heads with the tie rod.

7. The apparatus of claim 4, wherein the arm assembly comprises a cradle assembly and wherein the cradle assembly defines the at least one axis about which the supports and adjustment heads are configured to pivot.

8. The apparatus of claim 7, wherein the cradle assembly comprises a first cradle defining a first axis and a second cradle defining a second axis, and wherein the second cradle is mounted with the first cradle so as to pivot about the second axis.

9. The apparatus of claim 7, wherein the cradle assembly is connected with biasing members configured to bias the supports and adjustment heads into a set orientation.

10. The apparatus of claim 4, wherein the wherein the supports and adjustment heads are coupled to the arm assembly by a shaft defining a longitudinal axis of the tie rod adjustment apparatus, and wherein the supports and adjustment heads are rotatable about said shaft.

11. The apparatus of claim 10, wherein the arm assembly is coupled to an extension cylinder configured to extend the supports and adjustment heads into a deployed position to engage the tie rod and to retract the supports and adjustment heads into a retracted position.

12. The apparatus of claim 11, wherein the arm assembly is mounted to a frame via linear rails, and wherein the extension cylinder is coupled to the frame.

13. A method of adjusting a tie rod of a vehicle with a tie rod adjustment apparatus, wherein the tie rod adjustment apparatus comprises a pair of supports for locating and engaging with a tie rod and a pair of adjustment heads disposed between the supports, said method comprising:
extending the supports and adjustment heads from a retracted position and engaging the supports and adjustment heads with the tie rod so as to be in an engaged position in which the supports and adjustment heads are engaged with the tie rod;
moving the adjustment heads between the supports while the supports remain stationary on the tie rod, wherein said moving comprises;
engaging a first one of the adjustment heads with a jam nut of the tie rod and rotating the jam nut; and
engaging a second of the adjustment heads with a rotatable tie rod end of the tie rod and rotating the rotatable tie rod end;
wherein the pair of adjustment heads are moveable along the tie rod between the stationary supports for selectively engaging the first adjustment head with the jam nut and engaging the second adjustment head with the rotatable tie rod end;
retracting the supports and adjustment heads from the engaged position to the retracted position in which the supports and adjustment heads are disengaged from the tie rod.

14. The method of claim 13, wherein said moving comprises separately and independently moving the adjustment heads with respect to one another.

15. The method of claim 13, wherein the supports each comprise engaging ends for engagement with the tie rod, and wherein each engaging end comprises an opening for receiving the tie rod therein.

16. The method of claim 13, wherein the supports and adjustment heads are coupled to an arm assembly having at least one pivot axis, and wherein the method further comprises pivoting the supports and adjustment heads about the at least one pivot axis during said engaging the supports and adjustment heads with the tie rod.

17. The method of claim 16, wherein the arm assembly has a plurality of mutually perpendicular pivot axes, and wherein the method further comprises pivoting the supports and adjustment heads about the pivot axes during said engaging the supports and adjustment heads with the tie rod.

18. The method of claim 17, wherein the arm assembly comprises a cradle assembly defining two mutually perpendicular pivot axes.

19. The method of claim 18, wherein the supports and adjustment heads are coupled to the arm assembly by a shaft defining a longitudinal axis of the tie rod adjustment apparatus, and wherein the supports and adjustment heads are rotatable about said shaft.

20. The method of claim 13, further comprising an extension cylinder configured to extend the supports and adjustment heads into the engaged position and to retract the supports and adjustment heads into the retracted position.
